(19) United States
(12) Patent Application Publication
(10) Pub. No.: US 2006/0043063 A1
(43) Pub. Date: Mar. 2, 2006

(54) Electrically floating diagnostic plasma probe with ion property sensors

(76) Inventors: Leonard J. Mahoney, Fort Collins, CO (US); Daniel C. Carter, Fort Collins, CO (US); Daniel B. Doran, Fort Collins, CO (US)

Correspondence Address: JOHN D. PIRNOT;ADVANCED ENERGY INDUSTRIES, INC., 1625 SHARP POINT DR., FORT COLLINS, CO, 80525, US

(21) Appl. No.: 10/933,167

(22) Filed: Sep. 2, 2004

(51) Int. Cl. G01L 21/30; C23F 1/00

(52) U.S. Cl. 216/61; 216/67; 156/345.28

(57) ABSTRACT

A diagnostic plasma probe comprises ion sensors for measuring kinetic properties of plasma ions. Ion sensors of the invention include sensors for measuring differential ion flux, ion energy distributions, and ion incidence angle distributions at or near the surface of the probe. The measurement probe is electrically floating so as to cause minimal disruption of the properties of the processing plasma when disposed into a processing environment. A floating electrical bias is applied to the sensors to obtain measurements of ion properties.

### BACKGROUND OF THE INVENTION

1. Field of the Invention

This invention relates generally to the field of plasma processing, and more particularly to devices for in-situ measurement of plasma ion properties within a plasma processing system.

2. Brief Description of the Prior Art

In plasma processing systems, such as those widely employed in the manufacture of modern semiconductor devices, process results depend upon the physical, chemical, and electrical properties of the plasma. For example, the uniformity and selectivity of a plasma etching process will be strongly dependent upon the kinetic properties of energetic ions of the plasma at or near the surface of a work piece. In an anisotropic etch process, incident ions are made to strike a work piece surface with a narrow angular velocity distribution that is nearly perpendicular to the surface, thereby providing an ability to etch high aspect ratio features into the work piece. An ion velocity distribution that is substantially isotropic, however, can result in undesirable etching effects such as bowing or toeing of profile cavity sidewalls. The kinetic energy distribution of plasma ions is also important; ions arriving at the work piece surface may fail to activate chemical reactions needed for etching, whereas an excess of overenergized ions can damage the substrate surface. Quantitative information about the kinetic properties of ions in a processing plasma can therefore provide meaningful indications of the effectiveness of the process and quality of results.

U.S. Pat. No. 5,451,784 describes a diagnostic wafer containing an aluminum “placebo” wafer disk having embedded current probes and ion energy analyzers. Ion energy analyzers comprise conductive current collectors disposed within apertures in the wafer surface. Also within the apertures are grids connected to a variable electrical bias source. As the voltage on a discriminator grid is swept, the collector is able to collect only ions with energy levels that overcome the repulsive force generated by the grid. Current analyzing instrumentation connected by wires to the collectors is used to determine the energy distribution of the ions by comparing the current collected in response to changes in grid bias voltage.

U.S. Pat. No. 5,565,681 describes an ion energy analyzer having an element for controlling a critical angle for entry of ion trajectories into the analyzer. The energy analyzer comprises a micro-channel cover plate having holes for ion trajectory discrimination. A semicylindrical portion of the wall of each micro-channel is plated with a conductive material. By varying a bias voltage on the plated portion, various ion trajectory angles can be selected to be within the critical angle defined by the physical dimensions of the micro-channels. Ions of sufficient energy that enter the analyzer are collected by a collector element, generating current in a wire connected to the collector element.

A capacitance sensor for measuring ion flux and ion energy distribution at various locations in an ion beam or reactive ion etching process chamber is described in U.S. Pat. No. 6,326,794. Ions striking a surface conductor of the capacitance sensor cause a potential difference across a dielectric layer of the sensor, which provides a measure of the ion flux striking the sensor. The capacitance sensor is coupled to signal lines for routing the ion flux measurement signal outside the plasma reactor.

Wireless sensor probes have been described that provide in-situ measurements of specified plasma properties in a plasma processing system, such as measures of ion current or flux received by an onboard sensor device. Exemplary plasma probes are described, for example, in U.S. Pat. No. 6,691,068, and U.S. Patent Application No. 20040007326. It would be desirable to incorporate into an electrically floating diagnostic plasma probe an ability to measure not only aggregate properties of the plasma such as ion currents or fluxes, but also ion kinetic properties including, for example, distributions of ion energies and incidence angles at or near the surface of a work piece. It would be further desirable if the ion property sensors were minimally invasive to the plasma properties being measured. It would also be desirable if the ion property sensors could be manufactured and disposed upon a diagnostic probe device using common semiconductor fabrication techniques.

### SUMMARY OF THE INVENTION

This invention provides a diagnostic plasma measurement device having sensors for measuring properties of ions in a processing plasma. A measurement device of the invention generally comprises a primary substrate with onboard sensors for measuring one or more kinetic properties of ions at or near the surface of the substrate. The measurement device is electrically floating so as to cause minimal disruption of the properties of the processing plasma when disposed into a processing environment.

In one embodiment of the invention, a diagnostic plasma probe comprises a differential ion flux sensor for obtaining directionally resolved ion flux measurements at the probe surface. In a preferred embodiment, the differential ion flux sensor comprises collectors that receive ion flux on both horizontal and vertical surfaces of a sensor cavity. The probe is introduced into a plasma processing environment and the sensors and processing electronics of the probe are activated to collect data relating to horizontal and vertical components of ion flux, as well as other surface or plasma properties. The probe is fitted with an onboard wireless transceiver system for communication of data and instructions with a base station transceiver outside the plasma processing system.

In another embodiment, a diagnostic plasma probe comprises an ion energy sensor for determining the distribution of incident ion energies at the probe surface. The ion energy sensor comprises collectors that receive ion flux within a sensor cavity. The sensor further comprises a variable voltage bias source that causes ions having lower energy levels to be rejected, thereby allowing determination of the spread of ion energies about the net floating potential or biased potential of the probe surface. In a further embodiment of the invention, a diagnostic plasma probe comprises an ion incidence angle sensor. The ion incidence angle sensor comprises an array of spaced collectors embedded in a sensor cavity. In a preferred embodiment, the sensor further comprises an aperture that limits entry of ions into the sensor such that ions having particular incidence angles are collected only by certain of the collectors and not others, thereby allowing determination of an ion incidence angle distribution.

Embodiments of the invention also comprise electrodes for collection of electrons from the plasma for operation of ion sensors upon an electrically floating substrate. The electron collectors are electrically connected to the ion sensor circuitry and permit electrical biasing of the sensors without the need for an external biasing source. A common electrode may serve as an electron collector for multiple ion sensors of the invention. By dynamically pulsing the ion sensor circuitry, disturbance of plasma properties is minimized and onboard power resources are conserved.

Diagnostic probes of the invention are ideally suited for measuring in-situ plasma properties in semiconductor fabrication processes. Devices and technology of the invention are also suitable for use in other plasma applications and process environments. For example, embodiments may be employed in the production of flat panel displays, architectural glass, storage media, and the like. Substrates comprising technology of the invention may include but are not limited to all semiconductor substrates (silicon, gallium arsenide, germanium or others), as well as micro machine substrates, quartz, Pyrex and polymeric substrates.

### BRIEF DESCRIPTION OF THE DRAWINGS

FIG. 1 illustrates a wafer-based diagnostic plasma probe in accordance with one embodiment of the invention.

FIG. 2 illustrates a differential ion flux sensor in accordance with one embodiment of the invention.

FIG. 3 illustrates an ion energy distribution sensor in accordance with an embodiment of the invention.

FIG. 4 illustrates how currents measured by an ion energy distribution sensor may be used to determine a spread of ion energies, in accordance with one embodiment of the invention.

FIGS. 5 and 6 illustrate an ion incidence angle sensor in accordance with one embodiment of the invention.

FIGS. 7a and 7b illustrate an alternative embodiment of the invention comprising a pair of ion incident angle sensors with steering electrodes.

### DETAILED DESCRIPTION

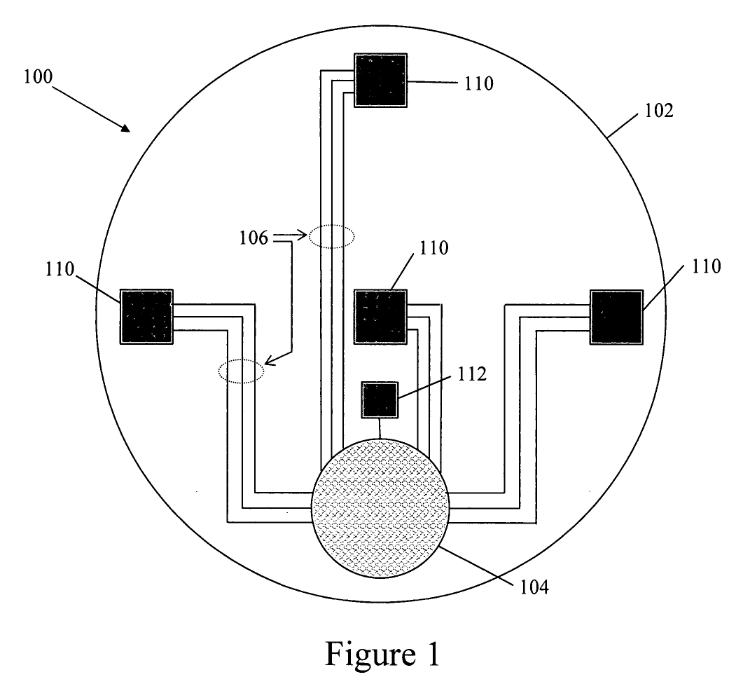

FIG. 1 illustrates a wafer-based plasma probe in accordance with one embodiment of the invention. Sensor probe 100 comprises a 200 mm or 300 mm silicon wafer primary substrate 102 having physical and electrical properties standard to typical semiconductor starting material. Probe 100 further comprises sensors 110 for measurement of plasma or surface properties. An electronics module 104 comprising onboard power and information processing and storage components of probe 100 is disposed upon the surface of probe substrate 102. Electronics module 104 may be provided as a prepackaged and sealed unit as described for example in U.S. patent application Ser. No. 10/815,124, owned by the assignee of the present application. Electronics module 104 further comprises a wireless communication interface that receives and transmits the sensor data outside of the plasma processing environment for further processing and analysis. Interconnections 106 are disposed upon substrate 102 for connection of sensors 110 to electronics module 104 and electrical components therein. A dielectric surface passivation layer (not shown) is disposed upon the wafer surface for physical protection and electrical isolation of probe components. Probe 100 is introduced into a plasma processing environment, at which time the apparatus sensors and microprocessor are activated or triggered to collect data relating to surface or plasma properties in close proximity to the apparatus surface.

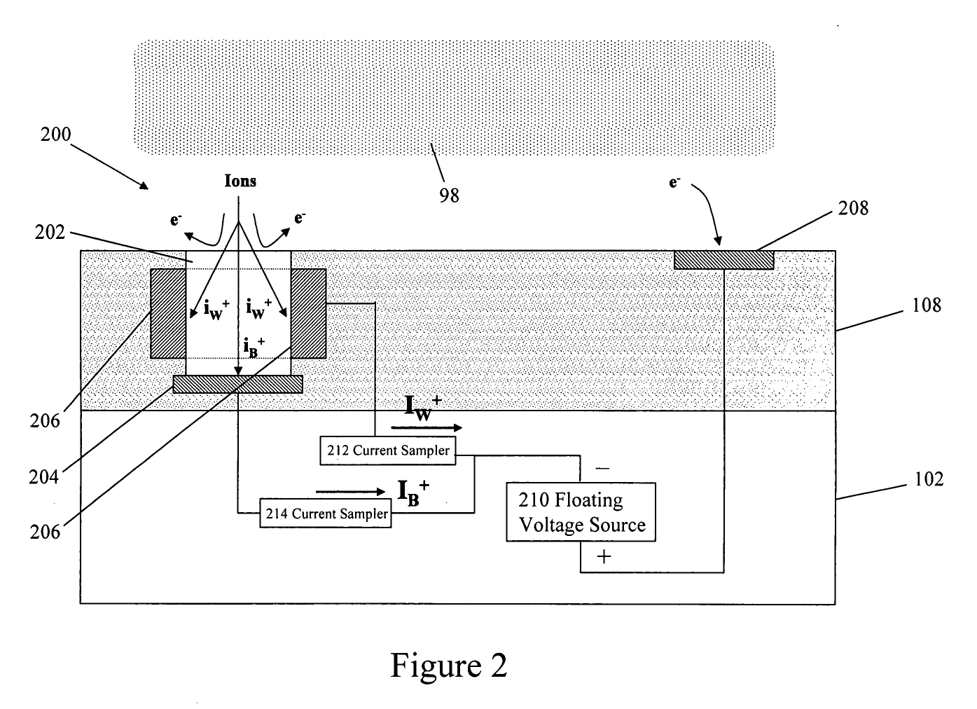

In accordance with the present invention, probe sensors 110 include sensors for measuring kinetic properties of the ions of the processing plasma. FIG. 2 illustrates a differential ion flux sensor in accordance with one embodiment of the invention. Sensor 200 is disposed into a dielectric layer 108 upon the surface of wafer substrate 102. Sensor 200 comprises a cylindrical cavity 202 in the dielectric surface 108 that is exposed to the plasma 98 of a plasma processing environment. The horizontal bottom surface of cavity 202 comprises horizontal ion flux collector 204. At least one vertical ion flux collector 206 is disposed upon a sidewall surface of cavity 202. An electron collector 208 is disposed upon the surface of wafer substrate dielectric 108 at a distance from sensor cavity 202. A floating bias voltage source 210 is provided between ion collectors 204 and 206 and electron collector 208. It will be understood that in FIG. 2 as well as in subsequent figures, the dimensions of certain illustrated features are not to scale but exaggerated for clarity.

When activated, floating bias voltage source 210 applies a negative bias voltage to ion collectors 204 and 206 and a corresponding positive bias voltage to electron collector 208. The bias voltages result in ion flux at ion collectors 204 and 206, and electron flux at electron collector 208. Preferably, the applied bias is sufficient only to reject electrons and collect ions at ion collectors 204 and 206, but not so great as to alter substantially the local electric fields of the plasma or the kinetic energies of ions collected. In a typical plasma processing environment, a sufficient and minimally invasive bias value may be on the order of 10 to 30 volts. As a result of the ion and electron flux collection, currents are generated and measured at current samplers 212 and 214. Current registered at current sampler 214 corresponds to a value of ion flux generated by ions i_{B} having normal or nearly normal incidence to the surface of the diagnostic probe, whereas current registered at current sampler 212 corresponds to flux from ions i_{W} having substantially non-normal angles of incidence. By comparing the respective current measurements, a measure of the anisotropy of ion flux at the probe surface is obtained.

Each of collectors 204, 206, and 208 is an electrically isolated conductive surface, preferably fabricated of a metal or metal alloy that is resistant to wear and chemical attack from the plasma environment. In general, sensor devices of the invention may be manufactured on a scale consistent with the dimensions of modern integrated circuitry, having features ranging in size from micrometers to nanometers. Use of traditional IC fabrication techniques to manufacture sensors directly in or on the probe substrate provides the ability to mass produce sensor devices having structures with highly accurate and repeatable dimensions. For example, sensor features may be formed using microlithography and plasma etching techniques, with conductors deposited using metal sputtering or electroplating followed by etching or chemical mechanical polishing. Materials used in fabricating these devices include but are not limited to silicon, silicon dioxide, and aluminum, as well as specialty (refractory) metals resistant to etch chemistries found in particular process environments.

As illustrated in FIG. 1, a plurality of ion property sensors may be disposed in an array about the surface of a diagnostic plasma probe, including arrays comprising sensors having varying diameters and depths. Electron collector 112 is common to all of ion sensors 110 with surface area sufficient to provide current to all ion sensors as needed. Alternatively, the electron collector may be subdivided into two or more smaller surfaces. Bias voltage source 210 and current samplers 212 and 214 may be disposed locally to sensor 200 or alternatively may be provided as part of a centralized probe electronics module. Probe electronics may include processing elements for applying corrections or transformations to measurement data received from sensors, storing electronically recorded data, and transmitting measurement data outside the process environment. Probe electronics may further include filtering elements that prevent common-mode RF noise, often present in the plasma processing environment, from corrupting the data being collected.

In the embodiment illustrated in FIG. 2, ion collectors 204 and 206 are disposed upon substantially horizontal and vertical surfaces of a single sensor cavity 202, respectively. In other embodiments, ion collectors are disposed at intermediate orientations, or combinations thereof, within one or more sensor cavities. Ion collectors may also be subdivided into two or more smaller surfaces within a sensor. Thus, in one alternative embodiment of the invention, the single annular vertical ion collector 206 illustrated in FIG. 2 is segmented into a plurality of vertical collectors disposed about the cylindrical sensor cavity sidewall. In another embodiment, vertical ion collectors are disposed on each of a plurality of sidewalls in a polygonal sensor cavity. By sampling the flux received by vertical collector individually, and/or sequentially as by multiplexing, additional directional information about ion kinetics is obtained. Alternatively, vertical ion collectors are disposed in alternative asymmetric locations in each sensor of an ion sensor array. Because each sensor collects tangential ion flux from a different angular direction, additional ion directional information is obtained in this embodiment as well.

The proportion of ions flux i_{B} received by horizontal collector 204 that is contributed by ions having non-normal angles of incidence is determined by the geometry of cavity 202, and in particular by the depth of the cavity in relation to the surface area of horizontal collector 204. In one embodiment of the invention, an array of ion sensors is provided having varying cavity diameters and depths. When distributed about the surface of a diagnostic probe, sensor arrays of the invention provide spatially resolved measurements of plasma ion characteristics. In another embodiment, an ion sensor comprises a vertical trench in the probe substrate with a width-to-depth aspect ratio that varies along the length of the trench. In alternative embodiments, a shield with an aperture is provided across the top of cavity 202 to limit the number of ions with substantially tangential trajectories that reach horizontal collector 204.

Floating bias voltage source 210 applies bias voltage to the sensors in pulses so as to minimize disturbance of the plasma properties and conserve onboard power resources. Application of a dynamically pulsed bias voltage also allows ion sensors to operate despite co-deposition of dielectric materials on the ion and electron collectors of the sensor. For example, reaction of plasma ions with the probe surface may create a thin polymer deposition that covers the measuring collector surfaces. Because the collectors are biased with a pulsed voltage, however, they remain capacitively coupled to the plasma and thus remain able to collect ion and electron currents despite the build up of thin dielectric coatings (i.e. tens to hundreds of Angstroms).

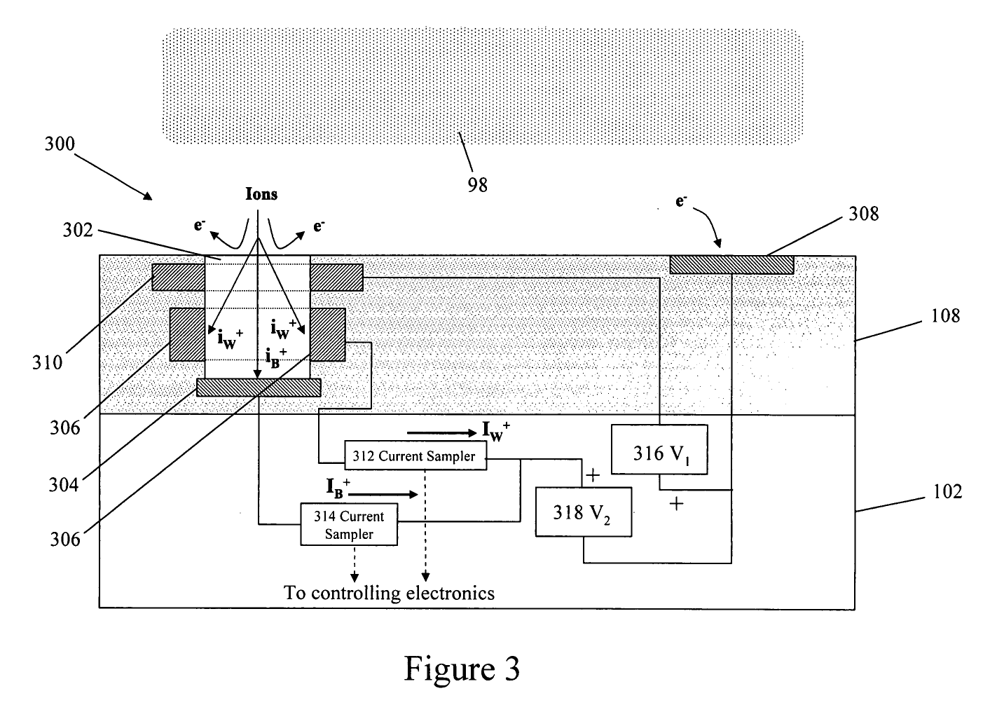

FIG. 3 illustrates an ion energy distribution sensor in accordance with a further embodiment of the invention. Sensor 300 comprises a cylindrical cavity 302 in the dielectric surface 108 that is exposed to the plasma 98 of a plasma processing environment. Horizontal ion flux collector 304 is disposed upon the horizontal bottom surface of cavity 302, and vertical ion flux collector 306 upon one or more of the cavity sidewalls. Biasing electrode 310 is provided between ion collectors 304 and 306 and the plasma 98, adjacent to the entrance of sensor cavity 302. A first floating bias voltage source 316 is provided between biasing electrode 310 and common electron collector 308. A second floating bias voltage source 318 is provided between ion collectors 304 and 306 and common electron collector 308. Although a single second floating bias source controlling both horizontal and vertical ion collectors 304 and 306 is shown in FIG. 3, it will be readily appreciated that an additional floating bias source may be added to control the bias voltage of the collectors independently.

First floating bias voltage source 316 applies a negative bias voltage −V₁ to bias electrode 310 sufficient to reject electrons and attract ions to the sensor. Ions entering the sensor result in flux at ion collectors 304 and 306, with flux i_{B} at horizontal collector 304 resulting from ions having normal or nearly normal incidence to the probe surface and flux i_{W} at vertical collector 306 resulting from ions having substantially non-normal angles of incidence. Due to the negative bias voltage −V₁ at bias electrode 310, ions arrive at collectors 304 and 306 with enhanced kinetic energy. As a positive bias voltage V₂ is applied from second floating bias voltage source 318 to collectors 304 and 306, the kinetic energy enhancement of arriving ions is reduced, and effectively canceled out when V₂=V₁. For increasingly positive values of V₂, ions having kinetic energy of less than (V₂−V₁) will be repelled by collectors 304 and 306. Thus, by varying positive bias voltage V₂, the ion flux measured by the collectors is due only to ions having correspondingly minimum values of kinetic energy or higher.

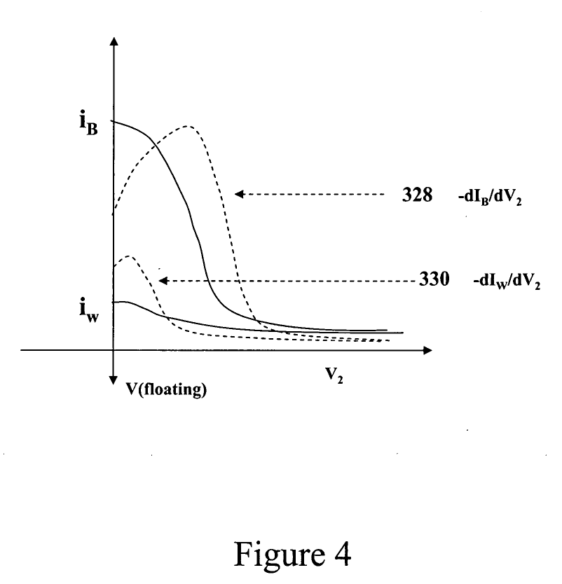

FIG. 4 illustrates how the measured ion currents i_{W} and i_{B} within the ion energy distribution sensor are used to determine a spread of ion energies about the floating potential of the sensor substrate. Differentiation of the measured ion currents as a function of V₂ results in a measure of ion kinetic energy distributions 328 and 330 as they are associated with i_{B} and i_{W}, respectively. However, the floating sensor configuration does not reference a system ground potential. Thus, the electrically floating sensor determines the spread of ion kinetic energy impinging on the side wall and base collectors relative to the floating potential of the sensor substrate. In this way, ion energy distribution sensor 300 is used to determine not only a measure of the anisotropy of the ion flux, but also the spread of the distribution of incident ion kinetic energies about the floating or RF self-bias potential of the device substrate, as observed at horizontal and vertical features within the probe. Information about the ion kinetic energy that discriminates between normal and angular ion current flux may then be correlated to process conditions and performance.

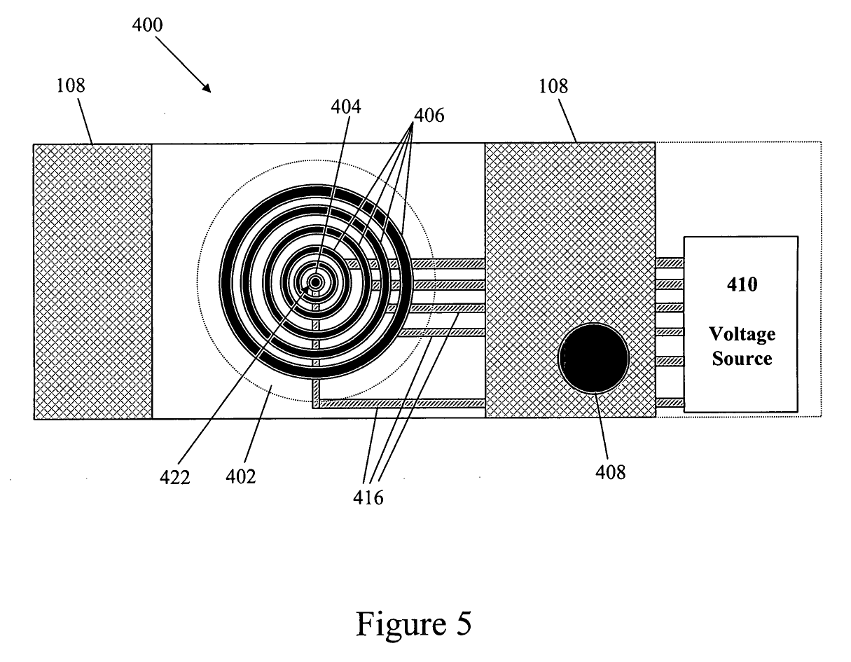

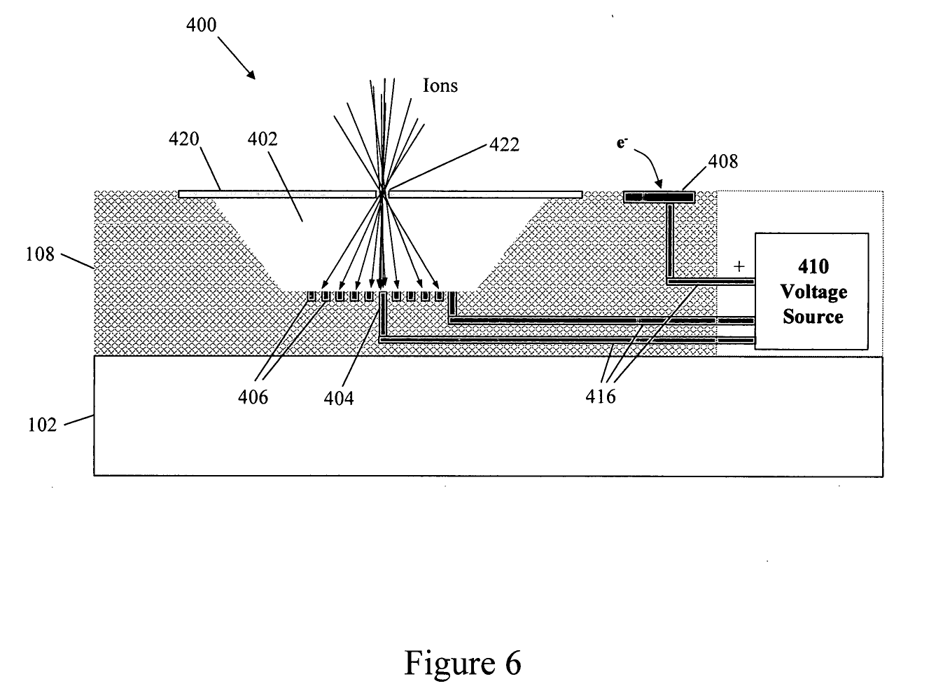

FIGS. 5 and 6 illustrate an ion incidence angle sensor in accordance with another embodiment of the invention. Sensor 400 comprises a center ion collector 404 together with concentric ion collectors 406 disposed upon a horizontal bottom surface of sensor cavity 402. Cavity shield 420 is disposed across the top of sensor cavity 402 with aperture 422 to permit entry of plasma ions into the sensor. Floating bias voltage source 410 is provided between ion collectors 404 and 406 and common electron collector 408. Alternatively, separate bias voltage sources may be provided for each of collectors 404 and 406.

Bias voltages applied by floating bias voltage source 410 results in ion flux at collectors 404, 406 due to ions entering the sensor through aperture 422. Ions entering the sensor with normal or near-normal angle of incidence are collected by center ion collector 404. Ions having substantially tangential trajectories may be collected by one of concentric ion collectors 406. The incidence angle distribution of ions entering aperture 422, together with the depth of cavity 402 and the width and spacing of collectors 406, determines the flux received by each collector. Current registered at current samplers (not shown) corresponds to a value of ion flux at each of collectors 404 and 406, which is provided to probe electronics for computation or analysis of the incidence angle distribution of plasma ions at the probe surface.

Ion sensors of the invention may be fabricated directly on the substrate of a plasma probe device using common semiconductor fabrication techniques, or may alternatively be fabricated separately and mounted as a discrete device upon the substrate. The cavity 402 of ion incidence angle sensor 400 is depicted in FIG. 6 as might typically result from creation by an isotropic etch process following deposition of shield layer 420 upon the substrate dielectric. Alternatively, a two step approach is used, similar to that used in the fabrication of MEM's devices having deep features requiring a cover or other shielding. A trench is etched, and the electrode structure is created at the bottom of the trench. A glass or other shield is then applied to the surface of the device using an appropriate adhesive, thereby covering the trench. The aperture can be pre-cut into the cover, requiring proper alignment during placement. Alternatively, the aperture is cut into the shield after placement.

Because ion collectors 404 and 406 must be electrically isolated from one another, radial gaps result in the sensor collection area at which ions having certain angles of incidence are not collected. To compensate for this effect, a means of steering ion trajectories within the ion incidence angle sensor is included in certain embodiments of the invention. In one example, the outermost of concentric ion collectors 406 is operated as a steering electrode through application of either a positive or negative voltage bias. The bias voltage steers plasma ions entering the sensor so as to modify in a predictable way the ion incidence angle distribution sensed by the array of measuring collectors. In this way, the flux from ions having trajectories that would otherwise fall within gap regions of the sensor may be quantified.

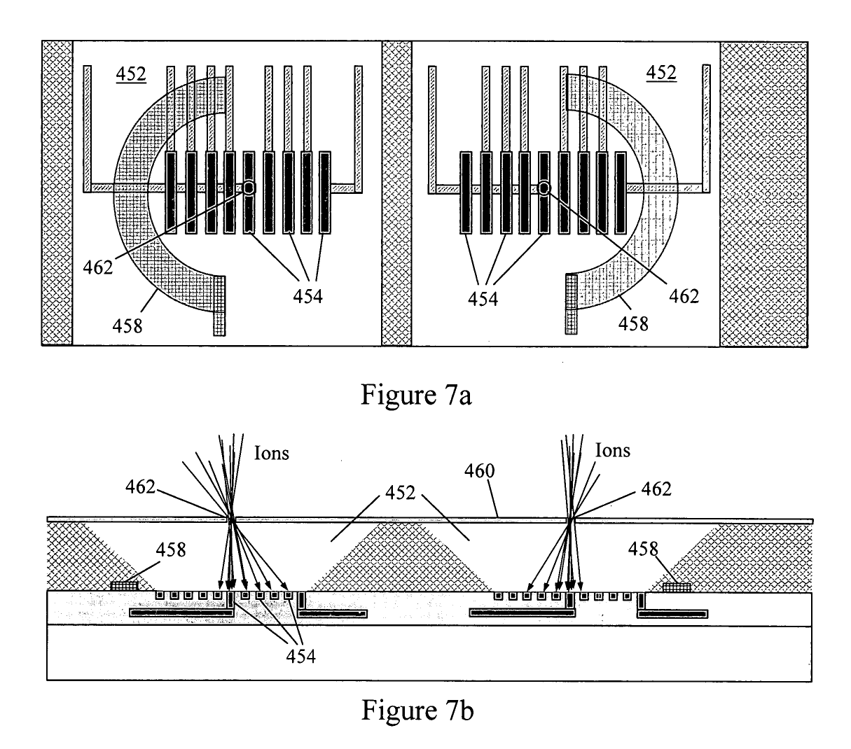

Steering of ion trajectories may also be accomplished by providing one or more independent steering electrodes around the measuring collectors of an ion sensor. FIGS. 7a and 7b illustrate one embodiment of a pair of ion incident angle sensors comprising steering electrodes. In this embodiment, arrays of parallel ion collectors 454 are disposed upon a horizontal bottom surface of sensor cavities 452. Alternatively, collectors are arrayed as concentric arcs. Apertures 462 of cavity shield 460 permits entry of plasma ions into the sensors. Steering electrodes 458 are disposed adjacent to ion collectors 454. A first floating bias voltage source provides a voltage bias to ion collectors 454, and a second floating bias voltage source provides a voltage bias to the steering electrodes 458. The steering bias voltage modifies the incidence angles of plasma ions entering the sensors, providing further data for analysis of ion incidence angle distribution.

Although there is illustrated and described herein specific structure and details of operation, it is to be understood that these descriptions are exemplary and that alternative embodiments and equivalents may be readily made by those skilled in the art without departing from the spirit and the scope of this invention. Accordingly, the invention is intended to embrace all such alternatives and equivalents that fall within the spirit and scope of the appended claims.

What is claimed is:

1. A diagnostic plasma measurement probe, comprising:
a) a primary substrate;
b) at least one plasma ion sensor disposed upon the primary substrate; and
c) a floating voltage source disposed upon the primary substrate, the floating voltage source providing a bias voltage to the at least one plasma ion sensor for measurement of ion kinetic properties.

2. The diagnostic plasma measurement probe of claim 1 wherein an array of plasma ion sensors is disposed upon the primary substrate.

3. The diagnostic plasma measurement probe of claim 1 wherein the floating voltage source provides a dynamically pulsed bias voltage to the at least one plasma ion sensor.

4. The diagnostic plasma measurement probe of claim 1 wherein the floating voltage source is disposed between the at least one plasma ion sensor and an electron collector disposed upon the primary substrate.

5. The diagnostic plasma measurement probe of claim 2, further comprising an electron collector common to plasma ion sensors of the array.

6. The diagnostic plasma measurement probe of claim 1 wherein the at least one plasma ion sensor comprises a differential ion flux sensor.

7. The diagnostic plasma measurement probe of claim 6 wherein the differential ion flux sensor comprises horizontal and vertical flux collector surfaces disposed in a cavity in the primary substrate.

8. The diagnostic plasma measurement probe of claim 1 wherein the at least one plasma ion sensor comprises an ion energy distribution sensor.

9. The diagnostic plasma measurement probe of claim 8 wherein the ion energy distribution sensor comprises horizontal and vertical flux collector surfaces disposed in a cavity in the primary substrate.

10. The diagnostic plasma measurement probe of claim 9, further comprising a biasing electrode for modifying the kinetic energies of plasma ions entering the sensor.

11. The diagnostic plasma measurement probe of claim 1 wherein the at least one plasma ion sensor comprises an ion incidence angle sensor.

12. The diagnostic plasma measurement probe of claim 11 wherein the ion incidence angle sensor comprises an array of concentric ion collectors disposed in a cavity in the primary substrate.

13. The diagnostic plasma measurement probe of claim 11 wherein the ion incidence angle sensor comprises an array of parallel ion collectors disposed in a cavity in the primary substrate.

14. The diagnostic plasma measurement probe of claim 11, further comprising a steering electrode that modifies the incidence angles of plasma ions entering the sensor.

15. The diagnostic plasma measurement probe of claim 1, further comprising a wireless communication transceiver mounted on the primary substrate disposed to transmit sensor measurement data.

16. The diagnostic plasma measurement probe of claim 1 wherein the bias voltage is between about 10 and 30 volts.

17. A method of measuring properties of a plasma processing environment comprising the steps of:
a) providing a measurement probe comprising a substrate, at least one plasma ion sensor disposed upon the substrate, and a floating voltage source disposed upon the substrate, the floating voltage source providing a bias voltage to the at least one plasma ion sensor;
b) disposing the measurement probe into a plasma processing system; and
c) collecting data relating to plasma ion kinetic properties in the plasma processing system using the measurement probe.

18. The method of claim 17, further comprising the step of wirelessly transmitting measurement data outside the plasma processing system.

19. The method of claim 17 wherein the floating voltage source is disposed between the at least one plasma ion sensor and an electron collector disposed upon the substrate.

20. The method of claim 17 wherein the at least one plasma ion sensor comprises a differential ion flux sensor.

21. The method of claim 20, further comprising the step of determining a measure of the anisotropy of ion flux at the probe surface using the collected data.

22. The method of claim 17 wherein the at least one plasma ion sensor comprises an ion energy distribution sensor.

23. The method of claim 22, further comprising the step of determining a spread of the distribution of ion kinetic energies at the probe surface using the collected data.

24. The method of claim 17 wherein the at least one plasma ion sensor comprises an ion incidence angle sensor.

25. The method of claim 24, further comprising the step of determining a distribution of the incidence angles of plasma ions at the probe surface using the collected data.

26. The method of claim 24, further comprising the step of modifying the incidence angles of plasma ions entering the sensor using a steering electrode disposed upon the substrate.
